(19) United States
(12) Patent Application Publication
(10) Pub. No.: US 2005/0173615 A1
(43) Pub. Date: Aug. 11, 2005

(54) Dc-dc converter

(75) Inventor: Bertrand Johan Edward Hontele, Oss (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/516,646

(22) PCT Filed: May 21, 2003
(86) PCT No.: PCT/IB03/02163

(30) Foreign Application Priority Data
Jun. 6, 2002 (EP) 02077212.5

(51) Int. Cl. G01J 1/20; H02M 1/12; G05F 1/10

(52) U.S. Cl. 250/203.1; 323/222; 363/44

(57) ABSTRACT

In a solar power system a boost converter is used comprising a choke and a transformer. Alternately the choke is boosted in a first time interval while power transfer is taking place in a second time interval by means of the transformer. When the input voltage supplied by a solar panel is increased the first time interval is decreased while the second time interval is increased. As a result the boost converter can handle a wide range of input voltages.

The invention relates to a DC-DC-converter of the type isolated boost converter comprising:
input terminals for connection to a DC power source,
a first circuit branch connecting the input terminals and comprising a series arrangement of an inductive element L and switching means,
a control circuit coupled to the switching means for generating a control signal for controlling the conductive state of the switching means,
a transformer equipped with
   a primary winding coupled to the switching means,
   a secondary winding magnetically coupled to the primary winding,
rectifying means coupled to the secondary winding, and
output terminals coupled to the rectifying means.

The invention also relates to a solar power converter and to a solar power system.

A DC-DC-converter as mentioned in the opening paragraph is known from DE 4426017. The known DC-DC-converter is particularly suitable to be used in a battery charger. It comprises a rectifier coupled to the input terminals and is meant to be powered from a mains supply supplying a low frequency AC voltage. The control circuit controls the switching means in such a way that the current drawn from the mains supply has an approximately sinusoidal shape and is substantially in phase with the mains supply voltage, so that a high power factor is obtained. Furthermore galvanic isolation is realized by the transformer that can be small since it carries a high frequency current, so that a big transformer at the input of the DC-DC-converter can be dispensed with.

Another technical field in which DC-DC-converters are in use is the field of solar power converters. Because of their high efficiency, forward converters are often used in this application. However, in spite of their high efficiency, the use of forward converters is associated with an important drawback. The photovoltaic cells that make up a solar panel are often arranged in series and the voltage present between the input terminals of the DC-DC-converter thus depends on the number of cells making up such a series arrangement. Generally, different users will prefer to use series arrangements comprising a different number of photovoltaic cells. Furthermore, during operation of the solar power converter, the light striking the solar panel comprising the cells will not be evenly distributed over the panel because of clouds, moving tree branches etc. Part of the cells will therefor not receive enough light to contribute to the total voltage that is present over the series. Since the distribution of the intensity of the light striking the solar panel will change continuously during operation, the number of contributing cells will generally change continuously as well, so that the same is true for the voltage produced by a series arrangement of cells. In case a constant output voltage is desirable, the duty cycle of the switch of a forward converter needs to be decreased, in case the voltage between its input terminals is increased. However, since photovoltaic cells act as current sources the increase in input voltage is associated with an increase in the electric power that is transferred from the input terminals of the forward converter to its output terminals. This combination of a decrease in duty cycle and an increase in power transfer cause a substantial increase in the amount of power dissipated in the switch of the forward converter. From the above it is clear that a forward converter is not a suitable DC-DC-converter for handling a wide range of input voltages with an acceptable efficiency.

The invention aims to provide a DC-DC-converter that has a comparatively high efficiency for a wide range of input voltages and is therefor suitable to be used in a solar power converter.

A DC-DC-converter as mentioned in the opening paragraph is therefore according to the invention characterized in that the control signal has a constant period T and in that the converter is further equipped with a current control loop for controlling average value over a period of the control signal of the current through the inductive element L at a constant level.

During a first part of a period of the control signal the voltage present between the input terminals causes a current to flow through the inductive element L and the switching means. The amplitude of this current increases linearly during this first part of the period. During the remaining part a current flows through the inductive element L and the primary winding of the transformer. The amplitude of this current decreases linearly. This current also causes another current to flow through the secondary winding of the transformer and through the rectifier so that power is supplied to the output terminals. When the number of contributing photovoltaic cells that are arranged in series between the input terminals of the DC-DC-converter is increased, the voltage between the input terminals is increased. Furthermore, since each photovoltaic cell acts as a current source, the power transferred from the solar panel to the input terminals of the DC-DC-converter increases as well. Since the voltage present between the input terminals is increased the current through the inductive element L increases faster during the first part of each period of the control signal. Since the average value of the current through inductive element L over a period of the control signal is controlled at a constant value and since the time duration of a period is constant, a faster increase of the current through inductive element L correspond to a decrease in the time duration of the first part of a period of the control signal and an increase in the time duration of the remaining part. In other words the duration of the time interval(s) in each period of the control signal during which power transfer to the output terminals takes place is increased. For this reason the increase in the amount of power that is transferred during each period of the control signal only causes a limited increase in the stress that the components of the DC-DC-converter are subjected to. The increase in the amount of power that has to be transferred from the input terminals to the output terminals during each period of the control signal is to a large extent compensated by the increase in the duration of the time interval in each period during which this power transfer is effected. It has been found that a DC-DC-converter according to the invention can operate with a relatively high efficiency for a wide range of input voltages and input power.

Good results have been obtained with embodiments of a DC-DC-converter according to the invention, wherein the DC-DC-converter comprises
a first circuit part for generating a first signal that represents the current through the inductive element L,
a second circuit part for generating a second signal that represents the predetermined reference value, and
a comparator equipped with
   a first input terminal coupled to the first circuit part,
   a second input terminal coupled to the second circuit part, and
   an output terminal coupled to the control circuit.

Alternatively, the control loop of a DC-DC-converter according to the invention may be equipped with
a first circuit part for generating a first signal that represents the average value of the current through the inductive element L,
a second circuit part for generating a second signal that represents a desired value of the average value of the current through the inductive element L, and
a third circuit part coupled with the first circuit part the second circuit part and the control circuit for comparing the first signal and the second signal and for adjusting the duty cycle of the control signal in dependency of the difference between the first and the second signal.

A very high efficiency over a wide range of input voltage was found for embodiments of a DC-DC-converter according to the invention, wherein the switching means comprises a first series arrangement of a first switching element and a second switching element, and a second series arrangement shunting the first series arrangement and comprising a third switching element and a fourth switching element, and wherein the primary winding is coupled between a common terminal of the first and the second switching element and a common terminal of the third and the fourth switching element. In such embodiments the control signal preferably effects a switching cycle comprising
a first operational state during a first time interval in which energy is transferred from the DC power source to the inductive element L,
a second operational state during a second time interval in which energy is transferred from the DC power source and from the inductive element L to the output terminals by means of a current flowing through the primary winding in a first direction,
a third operational state during a third time interval in which energy is transferred from the DC power source to the inductive element L,
a fourth operational state during a fourth time interval in which energy is transferred from the DC power source and from the inductive element L to the output terminals by means
   of a current flowing through the primary winding in a second direction,
and wherein the time duration of the first and the second time interval together is equal to a constant predetermined value and also equal to the time duration of the third and fourth time interval together.

In a DC-DC-converter according to the invention, the rectifying means is preferably equipped with a first series arrangement comprising two diodes and shunting the secondary winding and a second series arrangement comprising two further diodes and shunting the secondary winding.

Since a DC-DC-converter according to the invention can operate with a relatively high efficiency over a wide range of input voltages and input power, a DC-DC-converter according to the invention is very suitable for use in a solar power converter. Such a solar power converter may be used to supply power to a regular mains power supply. In that case, the solar power converter comprises an inverter coupled to the output terminals of the DC-DC-converter for generating a low frequency AC voltage out of the DC voltage present between the output terminals.

Such a solar power converter is very suitable for use in a solar power system that further comprises a solar panel equipped with photovoltaic cells.

An embodiment of a DC-DC-converter according to the invention will be explained making reference to a drawing. In the drawing

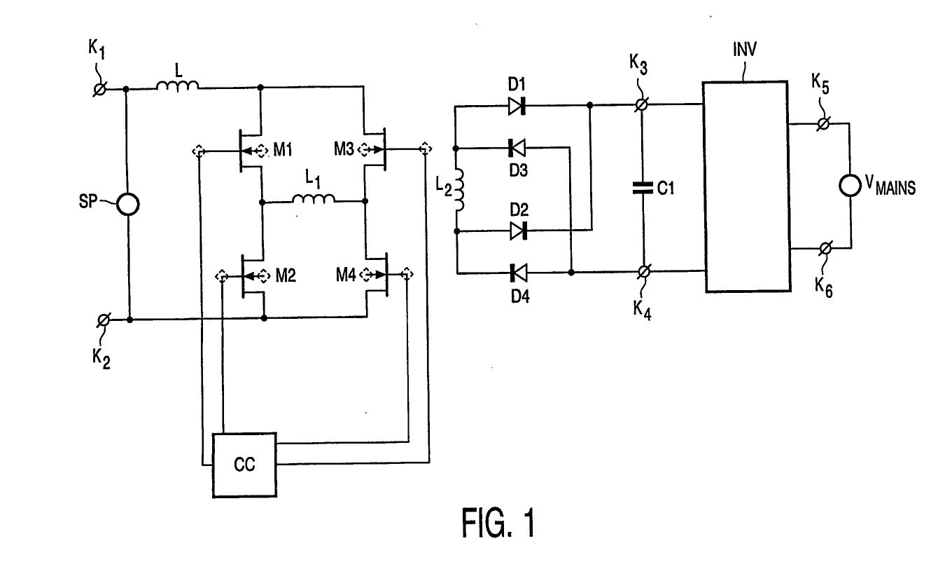

FIG. 1 shows an embodiment of a solar power system according to the invention, and

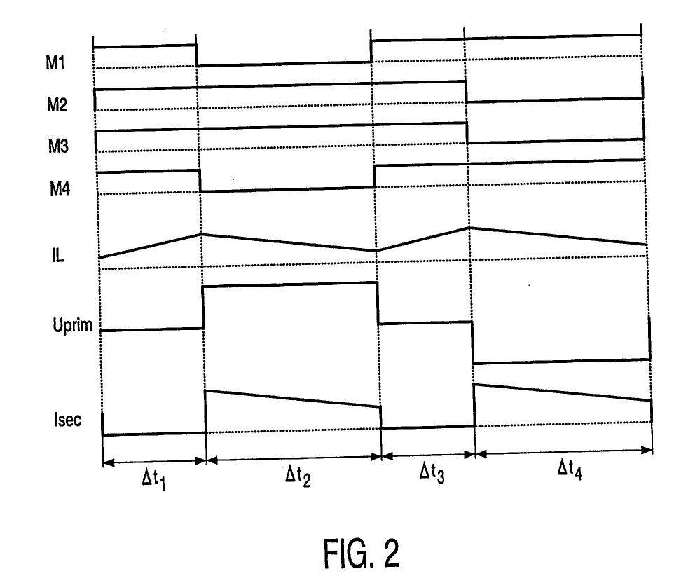

FIG. 2 shows the shape of different currents and voltages occurring in the DC-DC-converter shown in FIG. 1 in the course of a switching cycle.

In FIG. 1, K1 and K2 are input terminals for connection to a DC power source. The input terminals K1 and K2 are connected to a solar panel SP comprising a series arrangement of photovoltaic cells. Input terminals K1 and K2 are connected by means of a first circuit branch comprising a series arrangement of an inductive element L, a first switching element M1 and a second switching element M2. Switching elements M1 and M2 form a first series arrangement that is shunted by a second series arrangement comprising a third switching element M3 and a fourth switching element M4. CC is a control circuit for rendering the switching elements conductive and non-conductive. Respective output terminals of control circuit CC are connected to respective control electrodes of the four switching elements. A common terminal of the first switching element M1 and the second switching element M2 is connected to a common terminal of the third switching element and the fourth switching element by means of a primary winding L1. Primary winding L1 is magnetically coupled with secondary winding L2 and forms a transformer T together with secondary winding L2. A first end of secondary winding L2 is connected to a second end of secondary winding L2 by means of a series arrangement of diode D1, output terminal K3, capacitor C1, output terminal K4 and diode D4. Output terminal K4 is connected to the first end of secondary winding L2 by means of diode D3 and output terminal K3 is connected to the second end of secondary winding L2 by means of diode D2. Input terminals K1 and K2, inductive element L, switching elements M1, M2, M3 and M4, transformer T, control circuit CC, diodes D1, D2, D3 and D4 and output terminals K3 and K4 together form a DC-DC-converter of the type isolated boost converter. Diodes D1, D2, D3 and D4 together form rectifying means coupled to secondary winding L2. Capacitor C1 is a buffer capacitor. Output terminals K3 and K4 are connected to respective input terminals of an inverter INV for generating a low frequency AC voltage out of the DC voltage present between the output terminals K3 and K4 of the DC-DC-converter. Inverter INV can for instance be implemented as a full bridge circuit. Output terminals K5 and K6 of the inverter INV are connected to respective terminals of the mains supply.

The operation of the solar power system shown in FIG. 1 is as follows.

When sunlight strikes the solar panel a DC voltage V1 is present between the input terminals K1 and K2. The control circuit CC renders the switching elements conductive and non-conductive in accordance with a switching cycle that is illustrated in FIG. 2. Δt1, Δt2, Δt3 and Δt4 respectively are a first, a second, a third and a fourth time interval. During these time intervals the DC-DC-converter is subsequently in a first, a second, a third and a fourth operational state. The time duration of the first and the second time interval together is equal to a constant predetermined value and also equal to the time duration of the third and fourth time interval together. FIG. 2 shows the control signals controlling the conductive state of the switching elements M1, M2, M3 and M4 as a function of time. FIG. 2 also shows the current IL through the inductive element L, the voltage Uprim over the primary winding L1 and the current Isec through the secondary winding L2 as a function of time. During the first time interval the DC-DC-converter is in a first operational state in which the control circuit CC renders all the switching elements conductive. As a result a current IL flows from input terminal K1 through the inductive element L and all the switching elements to input terminal K2. During this first time interval the first winding L1 and the second winding L2 of the transformer T do not carry a current and no power is transferred from the input terminals to the output terminals of the DC-DC-converter. As can be seen in FIG. 2 the amplitude of the current IL increases linearly. By means of circuitry that is not shown in FIG. 1 a first signal representing the actual value of the current IL is compared with a second signal representing a predetermined reference value. When the first signal equals the second signal the control circuit CC changes the operational state of the DC-DC-converter from the first operational state into a second operational state. The DC-DC-converter is in this second operational state during a second time interval. In the second operational state the control circuit CC renders the second switching element M2 and the third switching element M3 conductive and the first switching element M1 and the fourth switching M4 element non-conductive. The current IL now flows from input terminal K1 through inductive element L, switching element M3, primary winding L1 and switching element M2 to input terminal K2. During the second time interval the amplitude of current IL decreases linearly. The secondary winding L2 also carries a current Isec with a linearly decreasing amplitude that charges capacitor C1, thereby transferring power from the input terminals K1 and K2 to the output terminals K3 and K4. When the input voltage V1 is increased the rate at which the amplitude of the current IL increases during the first time interval is increased as well. As a result the predetermined reference value will be reached sooner and the time duration of the first time interval will decrease. Since the control circuit CC maintains the time duration of the first and the second time interval together at a predetermined constant value, the time duration of the second time interval increases. Due to the fact that photovoltaic cells behave as current sources, the input current of the DC-DC-converter is independent of the input voltage, so that an increase in input voltage is always associated with an increase in input power. The increase in time duration of the second time interval makes it possible for the DC-DC-converter to transfer this increased input power to the output terminals of the DC-DC-converter with only a minor increase in the stresses on the components making up the DC-DC-converter. Thus the DC-DC-converter is capable of handling a wide range of input voltages and input powers. The third operational state of the DC-DC-converter is identical to its first operational state. The amplitude of the current IL increases during the third time interval. The fourth operational state differs from the second operational state in that the control circuit CC renders the first switching element M1 and the fourth switching element M4 conductive and the second switching element M2 and the third switching M3 element non-conductive. The current IL now flows from input terminal K1 through inductive element L, switching element M1, primary winding L1 and switching element M4 to input terminal K2. During the fourth time interval the amplitude of current IL decreases linearly. The secondary winding L2 also carries a current Isec with a linearly decreasing amplitude that charges capacitor C1, thereby transferring power from the input terminals K1 and K2 to the output terminals K3 and K4. The time duration of the third time interval will decrease when the input voltage and power are increased while the time duration of the fourth time interval is increased. Similar to the increase in time duration of the second time interval, this increase in the time duration of the fourth time interval enables the DC-DC-converter to handle the increased input power without stresses on components in the DC-DC-converter increasing.

The voltage that is present over capacitor C1 during operation of the solar power system is a substantially constant DC voltage. The inverter INV inverts this substantially constant DC voltage into a low frequency AC voltage in a way that is well known in the art. This low frequency AC voltage is supplied to the mains supply via the output terminals K5 and K6 of the inverter INV.

In a practical embodiment of the DC-DC-converter that is part of the solar system shown in FIG. 1, the operating frequency was chosen at 85 kHz and the output voltage equaled 400V. It was found that the DC-DC-converter could efficiently handle input voltages ranging from 80 V to 350 V.

1. DC-DC-converter of the type isolated boost converter comprising
input terminals for connection to a DC power source,
a first circuit branch connecting the input terminals and comprising a series arrangement of an inductive element L and switching means,
a control circuit coupled to the switching means for generating a control signal for controlling the conductive state of the switching means,
a transformer equipped with
a primary winding coupled to the switching means,
a secondary winding magnetically coupled to the primary winding,
rectifying means coupled to the secondary winding, and
output terminals coupled to the rectifying means, characterized in that the control signal has a constant period T and in that the converter is further equipped with a current control loop for controlling average value over a period of the control signal of the current through the inductive element L at a constant level.

2. DC-DC-converter as claimed in claim 1, wherein the DC-DC-converter comprises
a first circuit part for generating a first signal that represents the momentary amplitude of the current through the inductive element L,
a second circuit part for generating a second signal that represents a predetermined reference value, and
a comparator equipped with
a first input terminal coupled to the first circuit part,
a second input terminal coupled to the second circuit part, and
an output terminal coupled to the control circuit.

3. DC-DC-converter as claimed in claim 1, wherein the control loop is equipped with
a first circuit part for generating a first signal that represents the average value of the current through the inductive element L,
a second circuit part for generating a second signal that represents a desired value of the average value of the current through the inductive element L, and
a third circuit part coupled with the first circuit part, the second circuit part and the control circuit for comparing the first signal and the second signal and for adjusting the duty cycle of the control signal in dependency of the difference between the first and the second signal.

4. DC-DC-converter according to claim 1, wherein the switching means comprises a first series arrangement of a first switching element and a second switching element, and a second series arrangement shunting the first series arrangement and comprising a third switching element and a fourth switching element, and wherein the primary winding is coupled between a common terminal of the first and the second switching element and a common terminal of the third and the fourth switching element.

5. DC-DC-converter according to claim 4, wherein the control circuit effects a switching cycle comprising
a first operational state during a first time interval in which energy is transferred from the DC power source to the inductive element L,
a second operational state during a second time interval in which energy is transferred from the DC power source and from the inductive element L to the output terminals by means of a current flowing through the primary winding in a first direction,
a third operational state during a third time interval in which energy is transferred from the DC power source to the inductive element L,
a fourth operational state during a fourth time interval in which energy is transferred from the DC power source and from the inductive element L to the output terminals by means of a current flowing through the primary winding in a second direction,
and wherein the time duration of the first and the second time interval together is equal to a constant predetermined value and also equal to the time duration of the third and fourth time interval together.

6. DC-DC-converter as claimed in claim 1, wherein the rectifying means is equipped with a first series arrangement comprising two diodes and shunting the secondary winding and a second series arrangement comprising two further diodes and shunting the secondary winding.

7. Solar power converter comprising a DC-DC-converter as claimed in claim 1.

8. Solar power converter as claimed in claim 7, comprising an inverter coupled to the output terminals of the DC-DC-converter for generating a low frequency AC voltage out of the DC voltage present between the output terminals.

9. Solar power system comprising a solar panel equipped with photovoltaic cells and a solar power converter as claimed in claim 7.
